(19) United States
(12) Patent Application Publication
(10) Pub. No.: US 2015/0326536 A1
(43) Pub. Date: Nov. 12, 2015

(54) SYSTEM AND METHOD FOR EXECUTION OF DEDICATED PERSONAS IN MOBILE TECHNOLOGY PLATFORMS

(71) Applicant: Cellrox, Ltd., Tel Aviv (IL)

(72) Inventors: Offir GONEN, Ramat Hasharon (IL); Oren LAADAN, New York, NY (US); Ranit R. FINK-ISAACS, Bit Arif (IL)

(73) Assignee: CELLROX, LTD., Tel Aviv (IL)

(21) Appl. No.: 14/709,918

(22) Filed: May 12, 2015

Related U.S. Application Data
(60) Provisional application No. 61/991,840, filed on May 12, 2014.

(51) Int. Cl. H04L 29/06; H04W 4/00

(52) U.S. Cl. CPC H04L 63/0421; H04W 4/008; H04L 63/105; H04L 63/0492

(57) ABSTRACT

A method and user terminal for executing an anonymous or limited persona on a mobile technology platform (MTP) are provided. The method includes configuring a persona to be an anonymous persona by hiding at least an activity performed within the persona; executing the anonymous persona in a background operation of the MTP; checking if a secret request to activate the anonymous persona has been received; and activating the anonymous persona in the foreground of the operation of the MTP, upon receiving the secret request.

### CROSS-REFERENCE TO RELATED APPLICATIONS

This application claims the benefit of U.S. Provisional Application No. 61/991,840 filed on May 12, 2014, the contents of which are hereby incorporated by reference.

### TECHNICAL FIELD

The present disclosure relates generally to execution of personas in a mobile technology platform (MTP), and more specifically to the execution of personas dedicated to maintain the privacy and anonymity of a user of the MTP.

### DESCRIPTION OF THE BACKGROUND

With the advance of modern mobile technology, people carry mobile devices with them wherever they go. A mobile technology platform, such as a smartphone, is used today for a variety of forms of communication such as calls, email correspondence, chats, and so on. These forms of communication may be performed by more than a single entity.

However, in some cases it is desirable for the user of such a device to adopt various identities while using the device, often based on the role the user is currently playing. Enabling different identities on the same device can be achieved by implementing different personas. Typically, each persona is associated with and attributes a unique set of the user's preferences. For example, the user may be utilizing the device for both personal and business uses, thus business and personal personas may be utilized.

Different personas may have different sets of restrictions and/or functionalities determined respective of the type of information and applications accessible through such personas. For example, one persona may be authorized to perform certain actions while another persona may be authorized to perform other actions. As another example, a “finance persona” may be configured to allow a trading application to trade stocks online while a “kids persona” may block any access to such applications. To this end, having multiple personas on the same mobile device enhances the user experience by providing access to different applications and/or different preferences for such applications installed on the mobile device based on the user's given needs.

Moreover, having multiple personas executed on the same mobile device allows the user to secure information and/or separate certain functionalities. As an example, a personal persona grants a user access to personal information such as, for example, a family contact list. A work persona allows the user of the mobile device to perform work related actions such as, for example, accessing an enterprise's secure information, accessing work-related email inboxes, and so on.

Although personas provide a security layer through isolation of access to functions to resources and applications, still activities performed by a user through any persona can be tracked, thus compromising the user privacy and confidentiality. For example, applications, websites, transactions, and communications accessed or otherwise performed by the user when operating in a persona can be tracked. Access to the user's activity can be obtained by a malicious bot, a hacker, and the like.

Currently, there is not a solution that allows fully secure or private operation of a persona in a multiple persona mobile technology platform. It would therefore be advantageous to provide a solution for a fully secure and private operation of a persona in a multiple persona mobile technology.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain exemplary embodiments include a method for executing an anonymous persona on a mobile technology platform (MTP). The method comprises configuring a persona to be an anonymous persona by hiding at least an activity performed within the persona; executing the anonymous persona in a background operation of the MTP; checking if a secret request to activate the anonymous persona has been received; and activating the anonymous persona in the foreground of the operation of the MTP, upon receiving the secret request.

Certain exemplary embodiments include a method for executing a limited persona on a mobile technology platform (MTP). The method comprises configuring a persona to be a limited persona by setting a device setting of the MTP to control the functionality of the MTP; limiting at least an activity performed within the persona; executing the limited persona in an operation of the MTP; checking if a secret request to activate the limited persona has been received; and activating the limited persona in the operation of the MTP, upon receiving the secret request.

Certain exemplary embodiments also include a user terminal for executing an anonymous persona on a mobile technology platform (MTP). The terminal comprises a user interface; a processing unit; and a memory, the memory containing instructions that, when executed by the processing unit, configure the terminal to: set a persona to be an anonymous persona by hiding at least identity details related to a user of the MTP and activities performed within the persona; execute the anonymous persona in a background operation of the MTP; check if a secret request to activate the anonymous persona has been received; and activate the anonymous persona in the foreground of the operation of the MTP, upon receiving the secret request.

Certain exemplary embodiments also include a method for activation and use of a limited persona on a mobile technology platform (MTP). The method comprises configuring a persona to be a limited persona by applying at least one restriction rule on the operation of the persona; activating the limited persona to execute on the MTP, upon receiving a request to activate the limited persona on the MTP; continuously monitoring the operation of the limited persona with respect to the at least one restriction rule; and terminating the execution of the limited persona in the foreground, upon violation of the at least one restriction by the limited persona.

Certain exemplary embodiments also include a user terminal for executing a limited persona on a mobile technology platform (MTP). The terminal comprises a user interface; a processing unit; and a memory, the memory containing instructions that, when executed by the processing unit, configure the terminal to: set a persona to be a limited persona by applying at least one restriction rule on the operation of the persona;

activating the limited persona to execute on the MTP, upon receiving a request to activate the limited persona on the MTP; continuously monitoring the operation of the limited persona with respect to the at least one restriction rule; and terminating the execution of the limited persona in the foreground, upon violation of the at least one restriction by the limited persona.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic block diagram of a multiple-persona mobile technology platform (MTP) operative according to various embodiments.

FIG. 2 is a flowchart of the operation of an anonymous persona in a MTP according to an embodiment.

FIG. 3 is a flowchart of the operation of a limited persona in a MTP according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

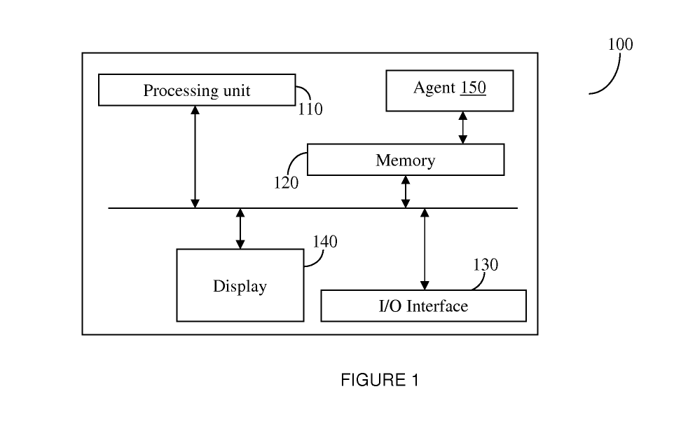

FIG. 1 is an exemplary and non-limiting schematic diagram of multiple-persona mobile technology platform (MTP) 100 operable according to various disclosed embodiments.

The MTP 100 is configured to execute one or more of personas thereon. A persona is defined with a unique set of user preferences associated with a respective persona. A persona refers to at least one role or identity associated with and assumable by a user of the MTP 100. The roles or identities of the user correspond to a unique execution environment. The execution environment may be a virtual execution environment, an operating system, a sandbox, a userspace container, a hypervisor, or any combination thereof. Each persona is associated with a unique set of metadata.

In an embodiment, a persona is a user profile defined as part of an operating system supporting multiple-user features in the MTP. Such a user profile is maintained and monitored by the MTP's operating system and allows to define under each profile a set of specific applications (apps), passwords, and other lock mechanisms associated with a specific user of the profile. For example, one user profile will be set for the owner of the MTP where all applications are available and another profile for a child using the MTP where only games may be available.

The MTP 100 typically includes a processing unit 110, a memory 120 connected to the processing unit 110, an I/O interface 130, and a display 140. In certain configurations, the display 140 is a touch-screen display which thereby can act as an I/O interface. The inputs (such as persona related requests) may be received in a form of gestures (e.g., scroll, tap, zoom, facial gesture, etc.), voice comments, keyboard stokes, a finger scanning, and more.

The memory unit 120 includes a plurality of instructions that can be executed by the processing unit 110 to at least perform the various embodiments disclosed herein. The processing unit 110 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing unit 110 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 110 to perform the various functions described herein.

In certain embodiments, the MTP 100 further comprises an agent 150 installed therein. The agent 150 may be executable code that is stored in the memory 120 and executed by the processing unit 110. Alternatively to the agent 150, a script that is supported by an operating system (OS) of the MTP 100 may be used. The MTP 100 is communicatively connected to a network (e.g., the Internet) through a wireless or wired connection.

The MTP 100 may be, but is not limited to, a cellular phone, a smart phone, a tablet device, a notebook computer, a laptop, an in-vehicle infotainment system (IVI), a wearable computing device, a set-top box, a smart TV, and the like.

According to various disclosed embodiments, dedicated personas can be created and executed on the MTP 100. The dedicated personas include, but are not limited to, anonymous and limited personas designed to allow secure, hidden, and private operation of a persona in the MTP 100.

In an embodiment, the anonymous persona is a persona configured to allow incognito operation of the persona by hiding the user's identity, alerts, and/or notifications generated by the persona. The anonymous persona may also prevent potential tracking and revealing of user's activities, information, notifications, actions, and so on. The anonymous persona can be executed in the background and the foreground of the MTP 100. Typically, the execution of the anonymous persona occurs in the background, without providing any access to any information, notifications, or alerts gathered or otherwise generated by the persona. In that way, the operation of the anonymous persona is kept hidden. In an embodiment, the activation and execution of the anonymous persona turns to the foreground upon receiving a predefined secret gesture and/or command through the I/O interface 130.

In one embodiment, when the anonymous persona is executed in the background, any persona executed in the foreground has no visibility to the anonymous persona. In another embodiment, an indication message is generated by the anonymous persona, executed in the background, and displayed by another (different) persona, executed in the foreground. Such indication may inform the user to switch to the anonymous persona in response to a predefined event. As an example, when receiving an incoming call designated to the anonymous persona while operating in another persona, an indication message is displayed on the display unit 140 informing a user that is able to access the anonymous persona of the incoming call.

The user may set which indications and/or alerts should be displayed on the display unit 140 when the anonymous persona is in the background. The indications may include alerts and notifications. For example, the user may control if alerts that occur while the anonymous persona is in the background can be passed to the foreground. If not, alerts will not pass to the foreground and no indication of the alert will be output. The control over alert indications keeps the secrecy of the anonymous persona.

In another embodiment, the user may choose to allow the indication of alerts while the anonymous persona is in the foreground. If the anonymous persona is in the foreground it is exposed, thereby indicating the alert will not expose its secrecy. In another embodiment, if alerts are missed while the anonymous persona was in the background, the system may display a notification of the missed alert when the anonymous persona switches to the foreground.

The user may choose to control how or if notifications are displayed while the anonymous persona is in the background. For example, to keep the secrecy of the anonymous persona, the user may choose to mute any notifications occurring in the background anonymous persona. The notifications are displayed only when the anonymous persona switches to the foreground.

In an embodiment, incoming calls to the anonymous persona can be controlled. For example, the calls are displayed if they are either to a dedicated anonymous (or incognito) phone line, an existing contact defined only in the anonymous persona, and so on.

As noted above, the activation and execution of the anonymous persona in the foreground is enabled by a predefined secret gesture and/or command through the I/O interface 130 (or display 140). Examples for such gestures and/or commands include a secret tap sequence on the display 140, a secret finger or multi-finger gesture, a secret voice command (e.g., “open sesame”), a secret whistle tune, dialing a special phone number in the phone dialer, finger scanning, an object recognition, i.e., photographing a specific object (i.e. photographing a certain key in the keychain), a facial gesture recognized through a photo of a certain person with a certain facial gesture, a secret passcode, and so on. For example, an anonymous persona executes in the background until the user dials a non-existent phone number.

In an embodiment, the anonymous persona may be activated based on a proximity of the MTP 100 to near field communication (NFC) objects. For example, when entering a classified office room with a NFC reader, the MTP 100 may also switch to the anonymous persona.

In an embodiment, the user may control the device setting of the anonymous persona executed in the foreground. The device settings that can be controlled include, for example, a GPS location, i.e., the user may choose that the GPS to be turned off when the persona is in the foreground to eliminate any option for location tracking; and 3G network, i.e., the user may choose that the 3G network to be turned off when the persona is in the foreground to eliminate any option for location tracking (3G protocol is vulnerable to location tracking). If the 3G network is turned off, calls may be made using a 2G network or a VOIP network.

Other device settings include anonymous browsing and virtual private network (VPN). For anonymous browsing, the user may choose that the web browsing will be in an incognito mode while the anonymous persona is in the foreground using online anonymity methods, such as Tor. In addition, the user may set the anonymous web browsing will be secure while the anonymous persona is in the foreground using a VPN.

According to certain exemplary embodiments, the activation of the anonymous persona may be performed automatically based on one or more activation parameters and activation conditions. In such embodiments, the activation parameter may be generated by the anonymous persona and compared to a set of predefined activation conditions. When at least one activation condition has been satisfied, the activation of the anonymous persona in the foreground occurs. Techniques for activation of personas based on parameters and conditions can be found in U.S. patent application Ser. No. 14/560,958, filed Dec. 5, 2014 entitled “SYSTEM AND METHOD FOR ACTIVATION OF PERSONAS BASED ON ACTIVATION PARAMETERS RELATED TO A MULTIPLE-PERSONA MOBILE TECHNOLOGY PLATFORM (MTP),” assigned to the common assignee and the contents of which are hereby incorporated by reference.

In an embodiment, upon activation of the anonymous persona, information records generated during the operation of the anonymous persona are gathered. Such information records include, but are not limited to, browsing history, cookies, messages (e.g., IM messages, text messages, etc.) received or sent through the anonymous persona, phone calls log (missed calls, incoming calls, etc.), applications (“apps”) accessed during the operation of the anonymous persona, any information generated by such apps, and so on. In embodiment, the user can configure the anonymous persona with the specific type of information records to gather (e.g., only browsing history).

All information records gathered throughout the operation of the anonymous persona are deleted upon occurrence of a predefined clearing event. A clearing event includes, for example, exiting the anonymous persona, deleting the anonymous persona, switching the anonymous persona to the background operation of the MTP 100, a predetermined period elapsed from the creation of the at least one record, and so on.

According to alternative embodiment, the anonymous persona does not save any information records. That is, any record that is not required for the continuous operation of the anonymous persona is deleted upon its creation. It should be noted that management of the information records to be removed is performed in a centralized and consistent manner across all apps installed in the MTP 100.

In one embodiment, any persona operable in the multi-persona MTP 100 can be activated to operate in an anonymous mode. In this embodiment, a set of predefined information records are gathered while the persona is operating in an anonymous mode. The gathered records are deleted upon exiting the persona, deleting the persona, switching the anonymous persona to the background operation of the MTP 100, or when a predetermined period elapsed from the creation of the at least one record.

According to the disclosed embodiments, a limited persona is a persona configured to limit the access of a user to resources installed in the MTP 100 and/or accessible through the network. Examples for such resources may include “apps” installed in the MTP 100, personal information (e.g., contact lists, bank accounts, photos, documents, etc.), remote content (e.g., websites, web services, etc.), access to other personas in the MTP 100, and so on. For example, by using the limited persona, a parent can supervise the activity of a child using the MTP 100.

The restriction on the resources that can be accessed are defined through restriction rules. The restriction rules are stored in the memory 120 and are accessible, but cannot be modified by, a limited persona. In one embodiment, the restriction rule defines a resource that cannot be accessed by the limited persona. For example, a restriction rule may define an address (e.g., an IP address, a SIP address, a URL, a port number, etc.) that the limited persona cannot access, a list of telephone numbers (or any other contact information) that the limited persona cannot dial to, or receive calls from, and/or send/receive text or IM messages, an application identifier (ID) that cannot be activated, and so on.

According to another embodiment, a restriction rule may be threshold defined based on, for example, a time threshold or a usage threshold of the limited persona. Upon reaching such threshold, the limited persona is terminated or deactivated. De-activation may include switching the limited persona from the foreground to the background of the operation. For example, the usage limit may be based on a battery level. In an embodiment, the restriction rules can be set by IT personnel, a security policy associated with the persona, a server external to the MTP 100, and a user of the MTP 100.

The activation of the limited persona is initiated by receiving a predefined gesture and/or command through the I/O interface 130. Alternatively, the activation of the limited persona may be performed in response to activation rules and conditions as discussed in detail above.

In one embodiment, any persona operable in the multi-persona MTP 100 can be activated to operate in a limited-access mode. In this embodiment, the operation of such a persona is restricted by one or more restriction rules associated with the persona as discussed above.

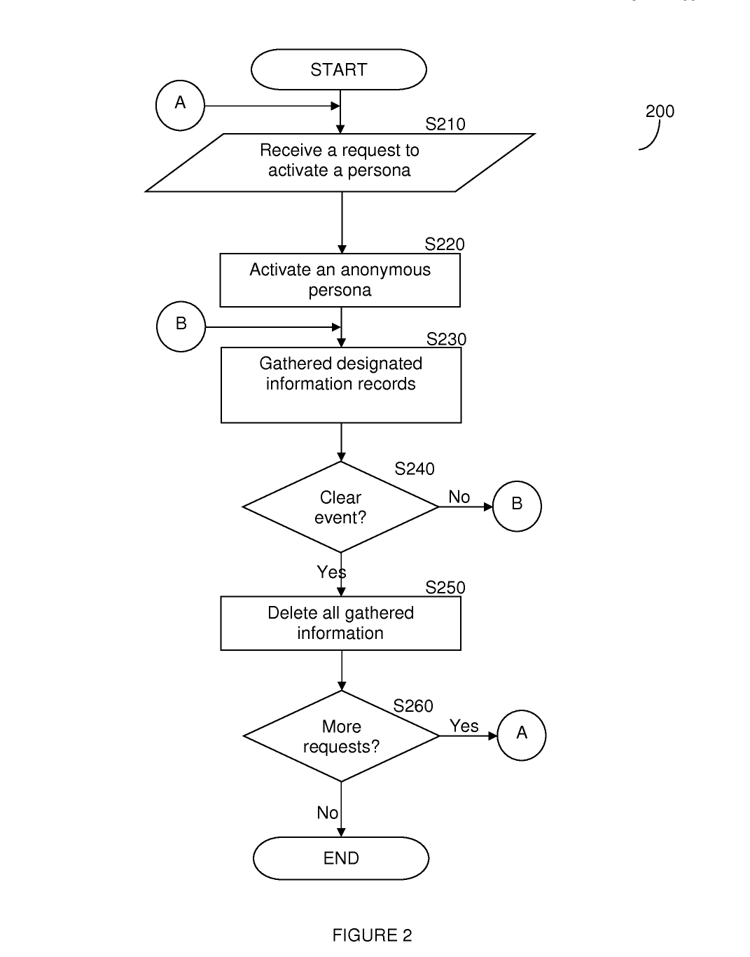

FIG. 2 shows an exemplary and non-limiting flowchart 200 illustrating the operation of an anonymous persona in a MTP according to an embodiment. In S210, a request to activate an anonymous persona on the MTP is received. Alternatively, the request may include changing the operation mode of the persona to operate in an anonymous mode. The request may be a predefined gesture and/or command received through an I/O interface of the MTP. As noted above, the request to activate an anonymous persona may be initiated by the user upon receiving an indication message from a persona executed in the background. The indication message informs the user to switch to the anonymous persona in response to a predefined event. In another embodiment, the activation of the anonymous persona (or an anonymous mode) may be performed in response to activation rules and conditions discussed in detail above.

In S220, the anonymous persona (or anonymous mode) is activated. In an embodiment, the activation of the anonymous persona results with switching the persona's execution from the foreground to the background.

In S230, in response to activation of the anonymous persona, designated information records are gathered. The information records are designated through a security setting of the anonymous persona. Non-limiting examples for such records are provided above.

In S240, a check is made if a clearing event has occurred, and if so execution continues with S250; otherwise, execution returns to S230. A clearing event may include, for example, exiting the anonymous persona, deleting the anonymous persona, switching the anonymous persona to the background operation of the MTP, a predetermined period elapsed from the creation of first/last information record, and so on.

In an embodiment, the clearing events and/or the various types of the information records to be gathered can be set (or designated) by information technology (IT) personnel, a security policy associated with the persona, a server external to the MTP, and a user of the MTP.

In S250, all the gathered information records are deleted and no traces for the user activity during the operation of the persona are left. As a result, the operation of the anonymous persona or a persona in an anonymous mode is kept hidden. In S260, it is checked whether additional requests received and if so, execution continues with S210; otherwise, execution terminates.

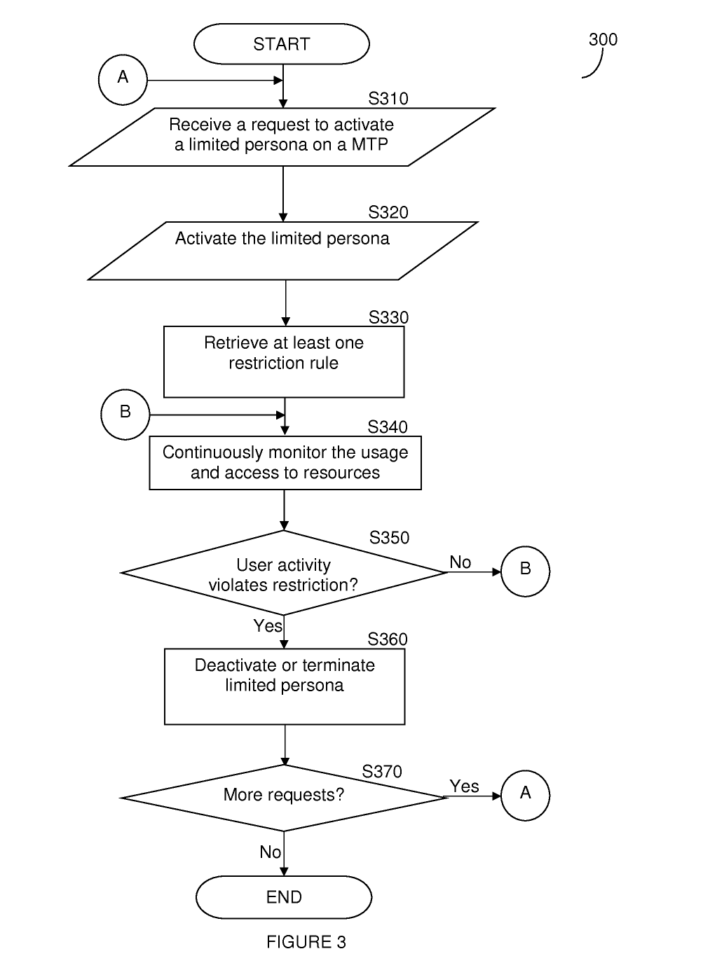

FIG. 3 shows an exemplary and non-limiting flowchart 300 of the operation of a limited persona in a MTP according to an embodiment. A limited persona is a persona (or a limited-access mode) configured to limit the access of user to resources installed in the MTP and/or accessible through the network.

In S310, a request to activate a limited persona on the MTP is received. Alternatively, the request may include changing the operation mode of any persona to operate in a limited-access mode. The request may be a predefined gesture and/or command received through an I/O interface of the MTP. In another embodiment, the activation of the limited persona (or a limited-access mode) may be performed in response to activation rules and conditions discussed in detail above.

In S320, the limited persona (or limited-access mode) is activated. In S330, in response to activation of the limited persona, at least one restriction rule to be utilized by the limited persona is retrieved from memory (e.g., memory 120). The restriction rule defines a resource that cannot be accessed by the persona or a threshold designating an allowable usage. Examples for restriction rules are provided.

It should be noted that restriction rules stored in the memory cannot be modified by the limited persona. In an embodiment, the restriction rules can be set by IT personnel, a security policy associated with the persona, a server external to the MTP, and a user of the MTP.

In S340, during the operation the limited persona, the usage and access to resources by the personas are continuously monitored and evaluated against each of the restriction rules. In S350, it is checked if the user activity through the limited persona violates at least one of the restriction rules. If so, at S360, the limited persona is terminated or deactivated; otherwise, execution returns to S340. In S370, it is checked whether additional requests were received and if so, execution continues with S310; otherwise, execution terminates.

As a non-limiting example, a restriction rule defined for the limited persona is a URL of a gambling website. When the MTP activates the limited persona, any HTTP request sent from a web browser application (executed within the limited persona) is monitored and evaluated. If the HTTP request includes the URL gambling website as specified in the rule, the execution of the persona is terminated or otherwise such attempt to browse the website is blocked.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for executing an anonymous persona on a mobile technology platform (MTP), comprising:
configuring a persona to be an anonymous persona by hiding at least an activity performed within the persona;
executing the anonymous persona in a background operation of the MTP;
checking if a secret request to activate the anonymous persona has been received; and
activating the anonymous persona in the foreground of the operation of the MTP, upon receiving the secret request.

2. The method of claim 1, wherein the configuration of the persona to be an anonymous persona further comprises hiding at least an identity detail related to a user of the MTP.

3. The method of claim 1, further comprising:
gathering information records generated during the operation of the anonymous persona in the foreground; and
deleting from the MTP the gathered information records, upon identification of a clearing event.

4. The method of claim 1, further comprising:
gathering information records generated during the operation of the anonymous persona; and
limiting access of the gathered information records on the MTP.

5. The method of claim 3, wherein the clearing event is any one of: exiting the anonymous persona, removing the anonymous persona, and elapse of a predetermined period of time from creation of a last information record.

6. The method of claim 1, wherein the secret request is at least one of: a user gesture and a command known only to the user of the MTP.

7. The method of claim 1, wherein the secret request is generated based on a proximity to a near field communication (NFC) object.

8. The method of claim 1, wherein the secret request is generated in response to at least one activation rule and at least one activation condition.

9. The method of claim 1, wherein the persona is defined with a unique set of user preferences associated with a respective persona.

10. The method of claim 1, wherein the persona is a user profile defined as part of an operating system supporting a multiple-user feature in the MTP.

11. The method of claim 1, wherein configuring the persona to be an anonymous persona further comprises:
setting at least one secret identification to be displayed in the foreground when the anonymous persona is executed in the background.

12. A non-transitory computer readable medium having stored thereon instructions for causing a processing system to execute the method according to claim 1.

13. A method for executing a limited persona on a mobile technology platform (MTP), comprising:
configuring a persona to be a limited persona by setting a device setting of the MTP to control the functionality of the MTP;
limiting at least an activity performed within the persona;
executing the limited persona in an operation of the MTP;
checking if a secret request to activate the limited persona has been received; and
activating the limited persona in the operation of the MTP, upon receiving the secret request.

14. The method of claim 13, wherein configuring the persona to be a limited persona further comprises:
setting a device setting of the MTP to control the functionality of the MTP when the limited persona is executed in the foreground.

15. The method of claim 13, wherein configuring the persona to be a limited persona further comprises:
setting a device setting of the MTP to control the functionality of the MTP when the limited persona is executed in the background.

16. A user terminal for executing an anonymous persona on a mobile technology platform (MTP), comprising:
a user interface;
a processing unit; and
a memory, the memory containing instructions that, when executed by the processing unit, configure the terminal to:
set a persona to be an anonymous persona by hiding at least identity details related to a user of the MTP and activities performed within the persona;
execute the anonymous persona in a background operation of the MTP;
check if a secret request to activate the anonymous persona has been received; and
activate the anonymous persona in the foreground of the operation of the MTP, upon receiving the secret request.

17. A method for activation and use of a limited persona on a mobile technology platform (MTP), comprising:
configuring a persona to be a limited persona by applying at least one restriction rule on the operation of the persona;
activating the limited persona to execute on the MTP, upon receiving a request to activate the limited persona on the MTP;
continuously monitoring the operation of the limited persona with respect to the at least one restriction rule; and
terminating the execution of the limited persona in the foreground, upon violation of the at least one restriction by the limited persona.

18. The method of claim 17, wherein the at least one restriction rule defines a resource that cannot be accessed by the limited persona.

19. The method of claim 17, wherein the at least one restriction rule defines at least one of: a usage threshold and a timing threshold.

20. The method of claim 17, wherein the request to activate the limited persona is at least one of: a predefined user gesture and a predefined command.

21. The method of claim 17, wherein the request to activate the limited persona is generated in response to at least one activation rule and at least one activation condition.

22. The method of claim 17, wherein the persona is defined with a unique set of user preferences associated with a respective persona.

23. The method of claim 17, wherein the persona a user profile defined as part of an operating system supporting a multiple-user feature in the MTP.

24. A non-transitory computer readable medium having stored thereon instructions for causing a processing system to execute the method according to claim 17.

25. A user terminal for executing a limited persona on a mobile technology platform (MTP), comprising:
a user interface;
a processing unit; and
a memory, the memory containing instructions that, when executed by the processing unit, configure the terminal to:
set a persona to be a limited persona by applying at least one restriction rule on the operation of the persona;
activating the limited persona to execute on the MTP, upon receiving a request to activate the limited persona on the MTP;
continuously monitoring the operation of the limited persona with respect to the at least one restriction rule; and
terminating the execution of the limited persona in the foreground, upon violation of the at least one restriction by the limited persona.
